(19) United States
(12) Patent Application Publication
(10) Pub. No.: US 2008/0018828 A1
(43) Pub. Date: Jan. 24, 2008

(54) BACKLIGHT ASSEMBLY, LIQUID CRYSTAL DISPLAY APPARATUS HAVING THE SAME AND METHOD FOR MANUFACTURING THE SAME

(75) Inventors: Kwang-Hoon LEE, Anyang-si (KR); Dae-Yoon JUNG, Yongin-si (KR); Choong-Sik KIM, Anyang-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/780,012

(22) Filed: Jul. 19, 2007

(30) Foreign Application Priority Data
Jul. 19, 2006 (KR) 1020060067189

(51) Int. Cl. F21V 9/16; F21V 8/00; H01J 9/00

(52) U.S. Cl. 349/65; 362/613; 445/23

(57) ABSTRACT

In a backlight assembly, a liquid crystal display (“LCD”) apparatus including the backlight assembly and a method for manufacturing the backlight assembly, the backlight assembly includes first, second, third and fourth lamps. The first to fourth lamps respectively face first to fourth side surfaces of a light-guide plate. Each include an input and an output terminal. The output terminals of the first and second lamps and of the third and fourth lamps, and the input terminals of the first and fourth lamps and of the second and third lamps, are adjacent to each other. A pair of the output terminals of the first and second lamps or the third and fourth lamps is connected to each other, so that the pair of lamps is arranged in an L-shape. The pair of the output terminals may be fed back to each input terminal, or grounded to a receiving container.

This application claims priority to Korean Patent Application No. 2006-67189, filed on Jul. 19, 2006 and all the benefits accruing therefrom under 35 U.S.C. § 119, the contents of which are herein incorporated by reference in its entirety.

### BACKGROUND OF THE INVENTION

1. Field of the Invention

The present invention relates to a backlight assembly, a liquid crystal display apparatus having the backlight assembly and a method for manufacturing the backlight assembly. More particularly, the present invention relates to a backlight assembly capable of maintaining brightness while having decreased thickness, a liquid crystal display apparatus having the backlight assembly and a method for manufacturing the backlight assembly.

2. Description of the Related Art

A liquid crystal display (“LCD”) apparatus displays images by using liquid crystal molecules. An LCD panel does not emit light by itself, but the LCD panel receives external light to display the images. Thus, the LCD panel requires a backlight assembly that provides the LCD panel with light. The backlight assembly includes a lamp, a reflective plate, an optical sheet, and so on.

The backlight assembly may be classified as either a direct-illumination type or an edge-illumination type according to a position of a lamp unit.

The backlight assembly having the edge-illumination type includes a light-guide plate. The lamp faces at least one side surface of the light-guide plate, so that the light passes through the light-guide plate and is incident into a display unit. When the LCD apparatus includes the edge-illumination type backlight assembly, brightness is decreased. Thus, a plurality of lamps faces one side surface of the light-guide plate for increasing the brightness.

However, when the plurality of the lamps faces one side surface of the light-guide plate, a width of an incident surface of the light-guide plate is greater than a total diameter of the lamps. Therefore, the thickness of the backlight assembly increases, and costs for manufacturing the backlight assembly increase as well.

In addition, since input and output lines are necessary for driving the lamp, the input and output lines become complicated as the number of the lamps increases.

### BRIEF SUMMARY OF THE INVENTION

An exemplary embodiment provides a backlight assembly capable of maintaining high brightness while having a relatively thin thickness and a simple line configuration.

An exemplary embodiment also provides a liquid crystal display (“LCD”) apparatus having the backlight assembly.

An exemplary embodiment still also provides a method for manufacturing the backlight assembly.

In an exemplary embodiment of backlight assembly, the backlight assembly includes a light-guide plate, a lamp part including first, second, third and fourth lamps, a receiving container and a power supply part.

Each of the lamps respectively faces first, second, third and fourth side surfaces of the light-guide plate and includes an input terminal and an output terminal. The receiving container receives the light-guide plate and the first, second, third and fourth lamps. The power supply part converts a voltage applied from an external source, and applies the voltage to the first, second, third and fourth lamps. The output terminals of the first and second lamps are adjacent to each other. The output terminals of the third and fourth lamps are adjacent to each other. The input terminals of the first and fourth lamps are adjacent to each other. The input terminals of the second and third lamps are adjacent to each other.

In an exemplary embodiment, a pair of the output terminals of the first and second lamps or the output terminals of the third and fourth lamps is electrically connected to each other. Each pair of lamps, the output terminals of which are electrically connected to each other is arranged in an L-shape. Each of the input terminals of the first, second, third and fourth lamps may be electrically connected to the power supply part. The pair of output terminals that are electrically connected to each other may be electrically connected to the power supply part and fed back to each input terminal.

In an exemplary embodiment, the pair of the output terminals that are electrically connected to each other may be grounded to the receiving container.

In an exemplary embodiment, the lamp part may further include a lamp cover disposed facing adjacent side surfaces of the light guide plate, holding the first, second, third and fourth lamps and reflecting light emitted by the first, second, third and fourth lamps. The lamp cover may be formed to be separated into sections, and each section of the lamp cover may have an L-shape, corresponding to the pair of lamps that has the L-shape. The pair of the output terminals that are electrically connected to each other may be grounded to the lamp cover.

In an exemplary embodiment, the backlight assembly may further include an optical element disposed on the light-guide plate and enhancing optical characteristics of light emitted from the lamps.

In an exemplary embodiment of LCD apparatus, the LCD apparatus includes a backlight assembly and a display unit. The backlight assembly supplies light. The display unit receives the light from the backlight assembly and displays images.

The backlight assembly includes a light-guide plate, a lamp part having first, second, third and fourth lamps, a receiving container and a power supply part. The first to fourth lamps respectively face first to fourth side surfaces of the light-guide plate. Each of the first to fourth lamps includes an input and an output terminal. The output terminals of the first and second lamps are adjacent to each other. The output terminals of the third and fourth lamps are adjacent to each other. The input terminals of the first and fourth lamps are adjacent to each other. The input terminals of the second and third lamps are adjacent to each other. The receiving container receives the light-guide plate and the first, second, third and fourth lamps. The power supply part converts a voltage applied from an external source, and applies the voltage to the first, second, third and fourth lamps. In an exemplary embodiment, a pair of the output terminals of the first and second lamps or the output terminals of the third and fourth lamps is electrically connected to each other. Each pair of the lamps, the output terminals of which are electrically connected to each other may be arranged in an L-shape. Each input terminal of the first, second, third and fourth lamps may be electrically connected to the power supply part. The pair of output terminals that are electrically connected to each other may be electrically connected to the power supply part and fed back to each of the input terminals of respective lamps.

In an exemplary embodiment, the pair of the output terminals that are electrically connected to each other may be grounded to the receiving container.

In an exemplary embodiment, the lamp part may further include a lamp cover disposed facing adjacent side surfaces of the light guide plate, holding the first, second, third and fourth lamps and reflecting light emitted by the first, second, third and fourth lamps. The pair of the output terminals that are electrically connected to each other may be grounded to the lamp cover.

In an exemplary embodiment of a method for manufacturing the backlight assembly, first, second, third and fourth lamps are arranged to respectively face first, second, third and fourth side surfaces of a light-guide plate, such that output terminals of the first and second lamps are adjacent to each other, output terminals of the third and fourth lamps are adjacent to each other, input terminals of the first and fourth lamps are adjacent to each other, and input terminals of the second and third lamps are adjacent to each other. A pair of the output terminals of the first and second lamps and a pair of the output terminals of the third and fourth lamps are electrically connected to each other.

The output terminals of the first and second lamps are adjacent to each other. The output terminals of the third and fourth lamps are adjacent to each other. The input terminals of the first and fourth lamps are adjacent to each other. The input terminals of the second and third lamps are adjacent to each other. A pair of the output terminals of the first and second lamps or the output terminals of the third and fourth lamps is electrically connected to each other.

In an exemplary embodiment, the method may further include connecting each input terminal of the first, second, third and fourth lamps to a power supply part.

In an exemplary embodiment of backlight assembly, the backlight assembly includes a light-guide plate, a lamp part including first and second lamps, a receiving container and a power supply part.

Each of the lamps respectively faces first and second side surfaces of the light-guide plate and includes an input terminal and an output terminal. The receiving container receives the light-guide plate and the first and second lamps. The power supply part converts a voltage applied from an external source, and applies the voltage to the first and second lamps. The output terminals of the first and second lamps are adjacent to each other.

In an exemplary embodiment, a pair of the output terminals of the first and second lamps is electrically connected to each other. Each pair of lamps, the output terminals of which are electrically connected to each other is arranged in an L-shape.

In an exemplary embodiment, each of the first, second, third and fourth lamps faces each of four side surfaces of the light-guide plate. Only one lamp is arranged to face each side surface of the light-guide plate, such as in a single-line arrangement. With the single line arrangement, light having substantially the same brightness may be generated in comparison with light generated from a backlight assembly having an arrangement of lamps that disposes the lamps in a double-line structure. In addition, brightness uniformity may be increased over a light-exiting surface of the light guide plate. In addition, by disposing the lamps in a single-line structure, a overall thickness of the LCD apparatus may be decreased. Furthermore, output terminals of a pair of lamps are electrically connected such that each pair of lamps are arranged in an L-shape, so that a complicated line structure may be simplified.

In an exemplary embodiment, in order to drive the lamps, a floating type and a grounding type lamp may be used. The floating type may enhance electrode life. The grounding type may simplify the line.

In an exemplary embodiment, as a pseudo-U lamp faces the light-guide plate and has an L-shape, the lamp cover is manufactured to have the L-shape to correspond to the shape of the pseudo-U lamp. Therefore, an assembly process of the lamp cover may be simplified, the line between the input terminal of each lamp and the power supply part may be simplified, and the lamp may be more reliably fixed and supported using the lamp cover.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 illustrates an exemplary embodiment of a driving concept of a pseudo-U lamp of a floating type;

FIG. 2 illustrates an exemplary embodiment of a driving concept of a pseudo-U lamp of a grounding type;

FIG. 3 is a perspective view illustrating an exemplary embodiment of a backlight assembly including a pseudo-U lamp of a floating type according to the present invention;

FIG. 4 is a perspective view illustrating exemplary embodiment of a backlight assembly including a pseudo-U lamp of a grounding type according to the present invention;

FIG. 5 is a perspective view illustrating another exemplary embodiment of a backlight assembly including a pseudo-U lamp of a grounding type according to the present invention; and

FIG. 6 is an exploded perspective view illustrating an exemplary embodiment of a liquid crystal display (“LCD”) apparatus according to the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “above” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “above” other elements or features would then be oriented “below” the other elements or features. Thus, the term “above” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed.

Hereinafter, the present invention will be explained in detail with reference to the accompanying drawings.

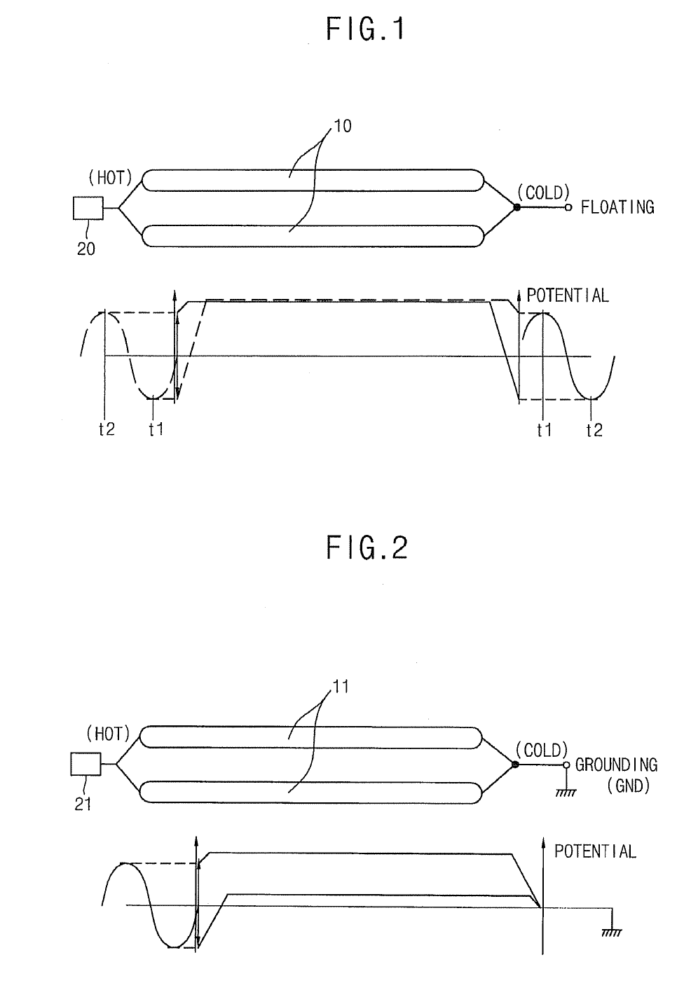

FIG. 1 illustrates a driving concept of a pseudo-U lamp of a floating type, and FIG. 2 illustrates a driving concept of the pseudo-U lamp of a grounding type.

A cold cathode fluorescent lamp (“CCFL”) includes electrodes at both ends of the CCFL. A relatively high voltage electric field applied to both electrodes causes electron emission, so that the CCFL is lighted and generates light. Thus, the CCFL needs two terminals for applying the high voltage electric field to both electrodes.

As illustrated in FIGS. 1 and 2, each of the CCFLs 10 and 11 includes two terminals. Each of the terminals is electrically connected to each electrode at an end of the CCFL. A first terminal of two terminals may be referred to as an input terminal HOT and a second terminal of the two terminals may be referred to as an output terminal COLD. The input terminals of the CCFLs 10 and 11 are electrically connected to each other, respectively, and then are electrically connected to the input terminal HOT, and the output terminals of the CCFLs 10 and 11 are electrically connected to each other, respectively, and then are electrically connected to the output terminal COLD. The input terminals HOT are electrically connected to inverters 20 and 21, respectively, and the output terminals COLD are electrically connected to the inverter 20 and ground, respectively.

A pseudo-U lamp is defined as a group of lamps of which output terminals are electrically connected to each other to form a U-shape as a whole. Although a straight lamp is not formed to have the U-shape, the pseudo-U lamp may be formed to have the U-shape by connecting each output terminal of two lamps, so that the pseudo-U lamp may have advantages of the U-shape lamp.

The inverter applies an alternating current (“AC”) voltage to the lamp to drive the lamp. When the lamp is driven by the inverter a lamp driving type may be classified as either a floating type or a grounding type. A voltage difference between both terminals of the lamp driven using the floating method or the grounding method is shown in Table 1. As shown in Table 1, voltages between both electrodes of the lamp are substantially the same.

TABLE 1

| | Voltage | Potential | Potential |
|---|---|---|---|
| | difference | difference | difference |
| | between both | between hot | between cold |
| | terminals | electrodes | electrodes |
| Floating type | V | V | V |
| Grounding type | V | 2 V | 0 V |

In the floating type lamp illustrated in FIG. 1, the voltage difference between both terminals of the lamp is substantially the same voltage V as that in the grounding type lamp, and a potential difference between hot electrodes HOT and the potential difference between cold electrodes COLD may also be substantially the same voltage V. Here, a plasma potential inside of a lamp tube is not considered.

However, in the grounding type illustrated in FIG. 2, the voltage difference between both terminals of the lamp is substantially the same voltage V as that in the floating type, but the potential difference between hot electrodes HOT is 2 V and the potential difference between cold electrodes COLD is 0 V.

The floating type has a complicated line structure since the output terminal COLD is electrically connected to the inverter 20, but electrode life may be increased.

However, the grounding type may simplify the line structure since the output terminal COLD is grounded to a peripheral region, but the electrode life of the grounding type is shorter than that of the floating type.

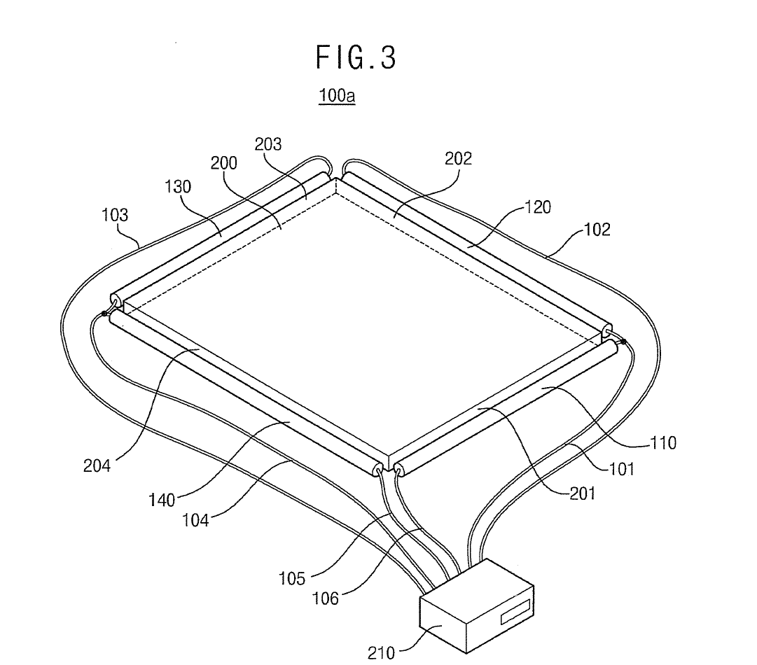

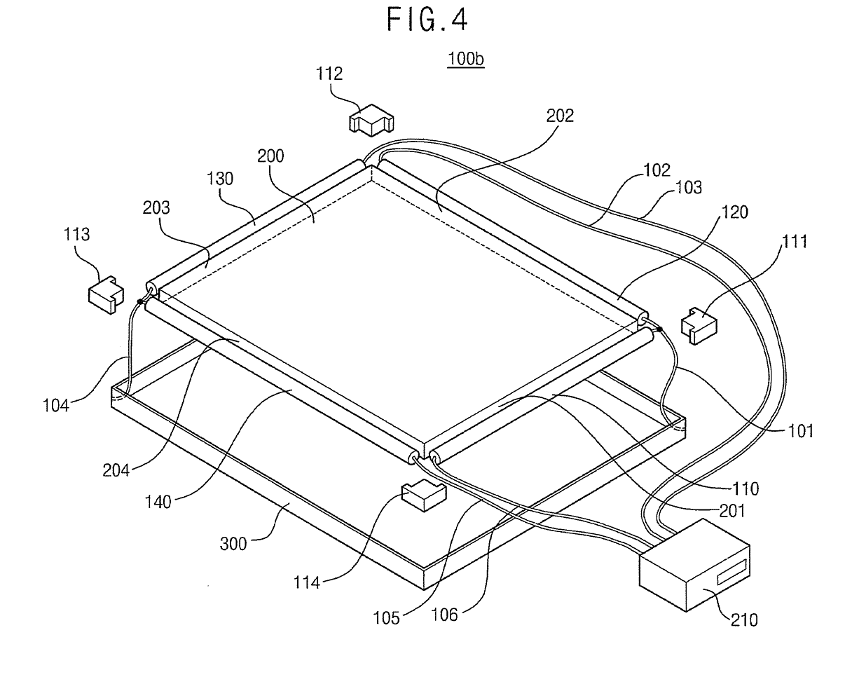

FIG. 3 is a perspective view illustrating an exemplary embodiment of a backlight assembly including a pseudo-U lamp of a floating type according to the present invention.

Referring to FIG. 3, a backlight assembly 100a includes a first lamp 110, a second lamp 120, a third lamp 130, a fourth lamp 140, a first line 101, a second line 102, a third line 103, a fourth line 104, a fifth line 105, a sixth line 106, a light-guide plate 200 and a power supply part 210. The backlight assembly 100a may further include a fixing element (not shown) for fixing the first, second, third and fourth lamps 110, 120, 130 and 140 to the light-guide plate 200.

The light-guide plate 200 includes a first side surface 201, a second side surface 202, a third side surface 203 and a fourth side surface 204. The light-guide plate 200 may further include a light-exiting surface and a light-incident surface.

The light-exiting and incident surfaces face each other, for connecting the first, second, third and fourth side surfaces 201, 202, 203 and 204 with one another. In exemplary embodiments, a material that may be used for the light-guide plate 200 may include, but is not limited to, polymethyl methacrylate (“PMMA”), polycarbonate (“PC”), etc.

Each of the first, second, third and fourth lamps 110, 120, 130 and 140 respectively faces the side surfaces 201, 202, 203 and 204 of the light-guide plate, and includes an input terminal and an output terminal.

As illustrated, the first lamp 110 is disposed adjacent to the first side surface 201 of the light-guide plate 200. The input terminal of the first lamp 110 is electrically connected to the power supply part 210 through the sixth line 106. The output terminal of the first lamp 110 is electrically connected to the output terminal of the second lamp 120 and is electrically connected to the power supply part 210 through the first line 101.

The second lamp 120 is disposed adjacent to the second side surface 202 of the light-guide plate 200. The input terminal of the second lamp 120 is electrically connected to the power supply part 210 through the second line 102. The output terminal of the second lamp 120 is electrically connected to the output terminal of the first lamp 110 and is electrically connected to the power supply part 210 through the first line 101.

The third lamp 130 is disposed adjacent to the third side surface 203 of the light-guide plate 200. The input terminal of the third lamp 130 is electrically connected to the power supply part 210 through the third line 103. The output terminal of the third lamp 130 is electrically connected to the output terminal of the fourth lamp 140 and is electrically connected to the power supply part 210 through the fourth line 104.

The fourth lamp 140 is disposed adjacent to the fourth side surface 204 of the light-guide plate 200. The input terminal of the fourth lamp 140 is electrically connected to the power supply part 210 through the fifth line 105. The output terminal of the fourth lamp 140 is electrically connected to the output terminal of the third lamp 130 and is electrically connected to the power supply part 210 through the fourth line 104.

As in the illustrated exemplary embodiment, the output terminals of a first pair of lamps including the first and second lamps 110 and 120 are electrically connected to each other. The output terminals of a second pair of lamps including the third and fourth lamps 130 and 140 are electrically connected to each other. Each of the first, second, third and fourth lamps 110, 120, 130 and 140 is disposed adjacent to each of the first, second, third and fourth side surfaces 201, 202, 203 and 204 of the light guide plate 200, respectively. The first pair of lamps are disposed corresponding to adjacent side surfaces 201 and 202 of the light guide plate 200 and the second pair of lamps are disposed corresponding to adjacent side surfaces 203 and 204 of the light guide plate 200. Thus, each of the pair of lamps, the output terminals of which are electrically connected to each other, has an L-shape as arranged relative to the light guide plate 200. The pseudo-U lamp of FIG. 3 may be considered to have the L-shape.

Advantageously, a minimal number of light sources is arranged to face side surfaces of the light-guide plate, such as disposing only one lamp to face each side surface of the light guide plate in a single-line arrangement, so that light having substantially the same brightness may be generated. In addition, uniformity of the light may be increased over a light-exiting surface of the light guide plate 200. In addition, by disposing the lamps in the single-line structure, a total thickness of the liquid crystal display (“LCD”) apparatus may be decreased. Furthermore, the output terminals of the pair of the lamps are electrically connected, and each of the pair of lamps is arranged to have the L-shape, so that a complicated line structure may be simplified.

The backlight assembly illustrated in FIG. 3 includes the output terminals electrically connected to the power supply part 210, so that the backlight assembly is driven using the floating method. The connected output terminals of the first and second lamps 110 and 120 are fed back to the input terminals of the first lamp 110 and the second lamp 120, respectively. The connected output terminals of the third and fourth lamps 130 and 140 are also fed back to the input terminals of the third lamp 130 and the fourth lamp 140, respectively. Advantageously, electrode life may be enhanced in the backlight assembly driven using the floating method.

The power supply part 210 is electrically connected to the input and output terminals of each lamp, for substantially constantly maintaining the voltage between the input and output terminals, so that each lamp may be driven.

FIG. 4 is a perspective view illustrating an exemplary embodiment of a backlight assembly including a pseudo-U lamp of a grounding type according to the present invention.

Referring to FIG. 4, a backlight assembly 100b includes a first lamp 110, a second lamp 120, a third lamp 130, a fourth lamp 140, a first line 101, a second line 102, a third line 103, a fourth line 104, a fifth line 105, a sixth line 106, a first lamp fixing element 111, a second lamp fixing element 112, a third lamp fixing element 113, a fourth lamp fixing element 114, a light-guide plate 200, a power supply part 210 and a receiving container 300 (hereinafter referred to as a bottom chassis).

The light-guide plate 200 includes a first side surface 201, a second side surface 202, a third side surface 203 and a fourth side surface 204. The light-guide plate 200 may further include a light-exiting surface and a light-incident surface. The light-exiting and incident surfaces face each other, for connecting the first, second, third and fourth side surfaces 201, 202, 203 and 204 with one another. Exemplary embodiments of a material that may be used for the light-guide plate 200 may include, but are not limited to, PMMA, PC, etc.

Each of the first, second, third and fourth lamps 110, 120, 130 and 140 respectively faces the side surfaces 201, 202, 203 and 204 of the light-guide plate 200, and includes an input terminal and an output terminal.

In the illustrated exemplary embodiment, the first lamp 110 is disposed adjacent to the first side surface 201 of the light-guide plate 200. The input terminal of the first lamp 110 is electrically connected to the power supply part 210 through the sixth line 106. The output terminal of the first lamp 110 is electrically connected to the output terminal of the second lamp 120 and is grounded to the bottom chassis 300 through the first line 101. The output terminals of the first lamp 110 and the second lamp 120 may be directly grounded to the bottom chassis 300, but the invention is not limited thereto.

The second lamp 120 is disposed adjacent to the second side surface 202 of the light-guide plate 200. The input terminal of the second lamp 120 is electrically connected to the power supply part 210 through the second line 102. The output terminal of the second lamp 120 is electrically connected to the output terminal of the first lamp 110 and is grounded to the bottom chassis 300 through the first line 101.

The third lamp 130 is disposed adjacent to the third side surface 203 of the light-guide plate 200. The input terminal of the third lamp 130 is electrically connected to the power supply part 210 through the third line 103. The output terminal of the third lamp 130 is electrically connected to the output terminal of the fourth lamp 140 and is grounded to the bottom chassis 300 through the fourth line 104. The output terminals of the third lamp 130 and the fourth lamp 140 may be directly grounded to the bottom chassis 300, but the invention is not limited thereto.

The fourth lamp 140 is disposed adjacent to the fourth side surface 204 of the light-guide plate 200. The input terminal of the fourth lamp 140 is electrically connected to the power supply part 210 through the fifth line 105. The output terminal of the fourth lamp 140 is electrically connected to the output terminal of the third lamp 130 and is grounded to the bottom chassis 300 through the fourth line 104.

As illustrated, the output terminals of the first and second lamps 110 and 120 are electrically connected to each other and are grounded to the bottom chassis 300. The output terminals of the third and fourth lamps 130 and 140 are electrically connected to each other and are grounded to the bottom chassis 300. Each of the first, second, third and fourth lamps 110, 120, 130 and 140 is disposed adjacent to each of the first, second, third and fourth side surfaces 201, 202, 203 and 204 of the light guide plate 200, respectively, such that each of a pair of lamps, the output terminals of which are electrically connected to each other, has an L-shape corresponding to adjacent side surfaces of the light guide plate 200. The pseudo-U lamp of FIG. 4 is fixed to have the L-shape.

The pseudo-U lamp having the L-shape of FIG. 4 has substantially the same effect as the exemplary embodiment in FIG. 3. Furthermore, the pseudo-U lamp of FIG. 4 includes the output terminals of the pair of the lamps that are not connected to the power supply part but are grounded to the bottom chassis, such that the line structure may be more simplified.

The backlight assembly 100b illustrated in FIG. 4 includes the output terminal that is not electrically connected to the power supply part 210 but is grounded to the bottom chassis 300, so that the backlight assembly is driven using the grounding method. Referring to the above-mentioned explanation regarding the grounding type of lamp, the potential difference between the connected output terminals of the first and second lamps 110 and 120 is about 0 V (See, Table 1). Also, the potential difference between the connected output terminals of the third and fourth lamps 130 and 140 is about 0 V. Therefore, the line structure may be simplified in the backlight assembly driven using the grounding method.

The first lamp fixing element 111 is disposed at an edge (e.g., corner) at which the first and second side surfaces 201 and 202 of the light-guide plate 200 meet each other, such that the first and second lamps 110 and 120 are separated from the light-guide plate 200 by a predetermined distance.

The second lamp fixing element 112 is disposed at an edge at which the second and third side surfaces 202 and 203 of the light-guide plate 200 meet each other, such that the second and third lamps 120 and 130 are separated from the light-guide plate 200 by the predetermined distance.

The third lamp fixing element 113 is disposed at an edge at which the third and fourth side surfaces 203 and 204 of the light-guide plate 200 meet each other, such that the third and fourth lamps 130 and 140 are separated from the light-guide plate 200 by the predetermined distance.

The fourth lamp fixing element 114 is disposed at an edge at which the fourth and first side surfaces 204 and 201 of the light-guide plate 200 meet each other, such that the fourth and first lamps 140 and 110 are separated from the light-guide plate 200 by the predetermined distance.

Advantageously, the power supply part 210 is electrically connected to the input and output terminals of each lamp, for substantially constantly maintaining the voltage between the input and output terminals. Thus, each lamp may be driven.

A portion of the bottom chassis 300 may be disposed under the light-guide plate 200, such as a bottom surface of the bottom chassis 300. The bottom chassis receives the light-guide plate 200, the first, second, third and fourth lamps 110, 120, 130 and 140 that are separated from the light-guide plate 200 by the predetermined distance, and the first, second, third and fourth lamp fixing members 111, 112, 113 and 114 that fix the first, second, third and fourth lamps 110, 120, 130 and 140 to the bottom chassis 300. In addition, the first and fourth lines 101 and 104 are grounded to the bottom chassis 300.

In an exemplary embodiment, when the bottom chassis 300 only includes a metallic material, the first line 101 is may be grounded to a position on the bottom chassis 300 adjacent or proximate to the connected output terminals of the first and second lamps 110 and 120. The fourth line 104 may be grounded to a position on the bottom chassis 300 adjacent or proximate to the connected output terminals of the third and fourth lamps 130 and 140. Alternatively, when the bottom chassis 300 includes the metallic material and a non-metallic material, such as a plastic material, the first and fourth lines 101 and 104 may be grounded to a metallic portion of the bottom chassis 300, e.g., a bottom surface, a sidewall surface or a metal member of the bottom chassis 300.

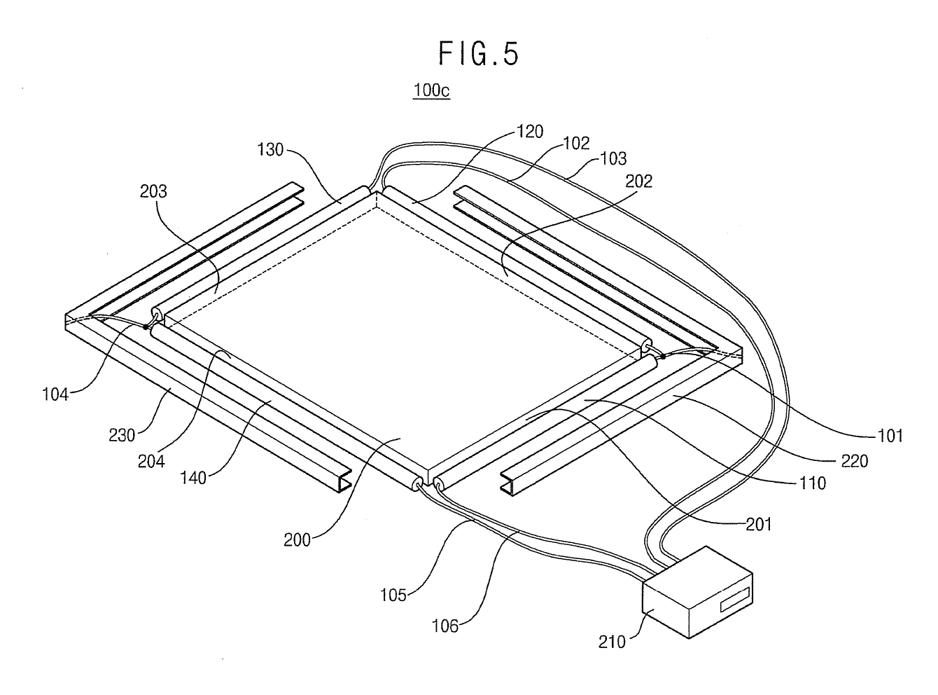

FIG. 5 is a perspective view illustrating another exemplary embodiment of a backlight assembly including a pseudo-U lamp of a grounding type according to the present invention.

Referring to FIG. 5, a backlight assembly 100c includes a first lamp 110, a second lamp 120, a third lamp 130, a fourth lamp 140, a first line 101, a second line 102, a third line 103, a fourth line 104, a fifth line 105, a sixth line 106, a first lamp cover 220, a second lamp cover 230, a light-guide plate 200 and a power supply part 210. The backlight assembly 100c of FIG. 5 is substantially the same as in FIG. 4 except for the lamp cover. Thus, the same reference numerals will be used to refer to the same or like parts as those described in FIG. 4 and any further repetitive explanation concerning the above elements will be omitted.

In the illustrated exemplary embodiment, the output terminals of the first and second lamps 110 and 120 are electrically connected to each other, and are grounded to the first lamp cover 220 through the first line 101. Likewise, the output terminals of the third and fourth lamps 130 and 140 are electrically connected to each other, and are grounded to the second lamp cover 230 through the fourth line 104.

The first lamp cover 220 has an L-shape. A cross-sectional surface of the first lamp cover 220 has a U-shape and covers the lamp. The first lamp cover 220 covers the first lamp 110 that faces the first side surface 201 of the light-guide plate 200, and the second lamp 120 that faces the second side surface 202 of the light-guide plate 200, simultaneously. An outer longitudinal surface, e.g., circumference, of the lamps is enclosed by the lamp cover and the side surface of the light guide plate.

The second lamp cover 230 has the L-shape. A cross-sectional surface of the second lamp cover 230 has the U-shape and covers the lamp. The second lamp cover 230 covers the third lamp 130 that faces the third side surface 203 of the light-guide plate 200, and the fourth lamp 140 that faces the fourth side surface 204 of the light-guide plate 200, simultaneously.

In an exemplary embodiment, the first and second lamp covers 220 and 230 having the L-shape may be manufactured such that the output terminals may be grounded to the first and second lamp covers 220 and 230. Advantageously, since the lamp cover has the L-shape, a manufacturing process of the lamp cover may be simplified, and a line structure between each input terminal of the lamp and the power supply part may be simplified. Also, the lamp may be more securely fixed and supported by the lamp cover.

As in the illustrated embodiment, the first and second lamp covers 220 and 230 are respectively single pieces, e.g. integrally formed. Alternatively, the first lamp cover 220 and/or the second lamp cover 230 may combine separate pieces, such as at adjacent ends, so as to form the L-shape.

The first and second lamp covers 220 and 230 hold the first, second, third and fourth lamps 110, 120, 130 and 140 so that the first, second, third and fourth lamps 110, 120, 130 and 140 are separated from the light-guide plate 200 by the predetermined distance. In an exemplary embodiment, the first and second lamp covers 220 and 230 reflect light emitted by the first, second, third and fourth lamps 110, 120, 130 and 140, so that the reflected light may enter the light-guide plate 200 again.

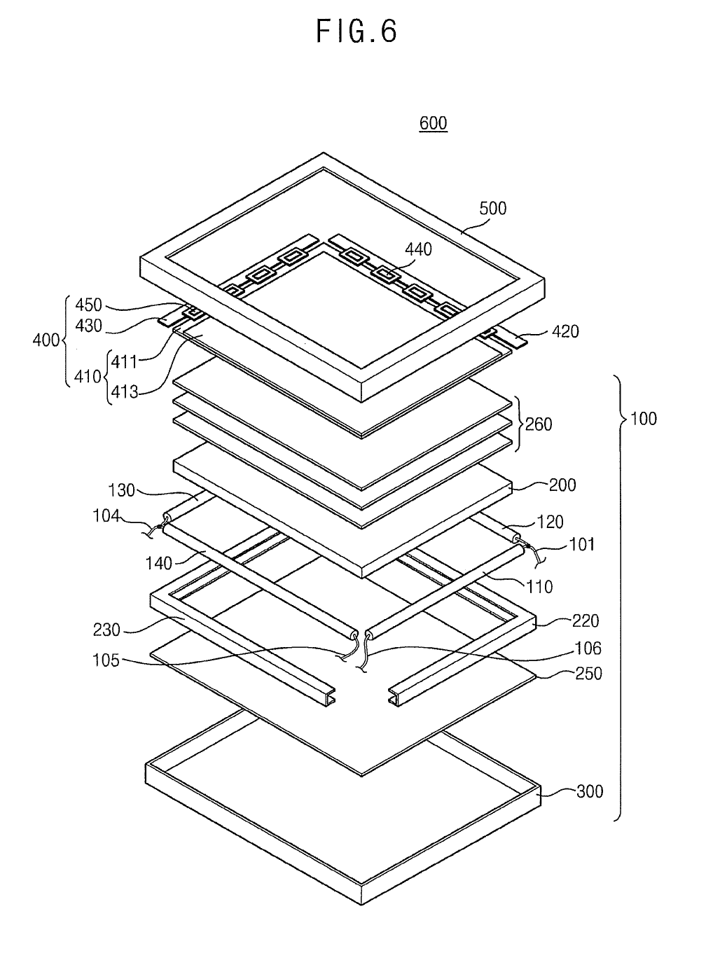

FIG. 6 is an exploded perspective view illustrating an exemplary embodiment of an LCD apparatus according to the present invention.

Referring to FIG. 6, an LCD apparatus 600 includes a backlight assembly 100 and a display unit 400. The backlight assembly 100 supplies light. The LCD apparatus 600 may further include a top chassis 500 and a mold frame (not shown).

The display unit 400 receives the light from the backlight assembly 100 and displays images. The display unit 400 includes an LCD panel 410, a data printed circuit board (“PCB”) 420, a gate PCB 430, a data tape carrier package (“TCP”) 440 and a gate TCP 450. The LCD panel 410 includes a thin-film transistor (“TFT”) substrate 413, a color filter substrate 411 and a liquid crystal layer (not shown).

The backlight assembly 100 includes a first lamp 110, a second lamp 120, a third lamp 130, a fourth lamp 140, a first line 101, a second line 102, a third line 103, a fourth line 104, a fifth line 105, a sixth line 106, a first lamp cover 220, a second lamp cover 230, a light-guide plate 200, a bottom chassis 300 and a power supply part (not shown).

In FIG. 6, the same reference numerals denote the same elements in FIG. 5, and thus detailed descriptions of the same elements will be omitted. In addition, the LCD apparatus 600 including the backlight assembly 100c of FIG. 5 is illustrated in FIG. 6, but the LCD apparatus 600 may include the backlight assembly 100a of FIG. 3 or the backlight assembly 100b of FIG. 4. In this case, the same reference numerals denote the same elements in FIG. 3 or FIG. 4, and thus detailed descriptions of the same elements will be omitted.

The backlight assembly 100 may further include optical sheets 260. The optical sheets 260 are disposed on (e.g., above) the light-guide plate 200 and control a viewing angle of the light emitted from the light-guide plate 200. In addition, the backlight assembly 100 may further include a reflective plate 250. The reflective plate 250 is disposed between the light-guide plate 200 and the bottom chassis 300, and reflects light that leaks from the light-guide plate 200 towards the light-guide plate 200 again.

The optical sheets 260, the light-guide plate 200, the first, second, third and fourth lamps 110, 120, 130 and 140, the first and second lamp covers 220 and 230, and the reflective plate 250 are fixed to the mold frame (not shown), and are received in the bottom chassis 300.

The display unit 400 is disposed on the optical sheets 260 and guided by the top chassis 500 combined with the bottom chassis 300 to face the bottom chassis 300.

As in the exemplary embodiments, each of first, second, third and fourth lamps faces each of four side surfaces of the light-guide plate, respectively. This arrangement of a single lamp corresponding to a single side surface of the light guide plate may be considered as a single-line structure. Only one lamp is arranged to face each side surface of the light-guide plate. Advantageously, light may be generated having substantially the same brightness as that from a backlight assembly having an arrangement of lamps that disposes multiple lamps on a side of the light guide plate, such as in a double-line structure. In addition, brightness uniformity may be increased over a light-exiting surface of the light guide plate. In addition, by disposing the lamps in the single-line structure, a total thickness of the LCD apparatus may be decreased. Furthermore, the output terminals of a pair of lamps are electrically connected such that the pair of lamps has an L-shape, so that a line structure may be simplified.

As in the illustrated embodiments, to drive the lamps, a floating type and a grounding type may be used. The floating type may enhance electrode life. The grounding type may simplify the line structure.

As in the illustrated embodiments, a pseudo-U lamp faces the light-guide plate and has the L-shape, a lamp cover is manufactured to have the L-shape to correspond to the shape of the pseudo-U lamp. Therefore, an assembly process of the lamp cover may be simplified, and the line structure between the input terminal of each lamp and the power supply part may be simplified. Also, the lamp may be relatively strongly fixed and supported using the lamp cover.

Having described the exemplary embodiments of the present invention and its advantages, it is noted that various changes, substitutions and alterations can be made herein without departing from the spirit and scope of the invention as defined by appended claims.

What is claimed is:

1. A backlight assembly comprising:
a light-guide plate;
a lamp part including first, second, third and fourth lamps respectively facing first, second, third and fourth side surfaces of the light-guide plate, each of the lamps including an input terminal and an output terminal, the output terminals of the first and second lamps being adjacent to each other, the output terminals of the third and fourth lamps being adjacent to each other, the input terminals of the first and fourth lamps being adjacent to each other, and the input terminals of the second and third lamps being adjacent to each other;
a receiving container receiving the light-guide plate and the first, second, third and fourth lamps; and
a power supply part converting a voltage applied from an external source, and applying the voltage to the first, second, third and fourth lamps.

2. The backlight assembly of claim 1, wherein a pair of the output terminals of the first and second lamps or the output terminals of the third and fourth lamps is electrically connected to each other, and
each pair of the lamps having the output terminals electrically connected to each other is arranged in an L-shape.

3. The backlight assembly of claim 2, wherein each of the input terminals of the first, second, third and fourth lamps is electrically connected to the power supply part.

4. The backlight assembly of claim 3, wherein the pair of the output terminals that are electrically connected to each other, is electrically connected to the power supply part and fed back to each input terminal of respective lamps.

5. The backlight assembly of claim 3, wherein the pair of the output terminals that are electrically connected to each other, is grounded to the receiving container.

6. The backlight assembly of claim 3, wherein the lamp part further includes a lamp cover disposed facing adjacent side surfaces of the light guide plate, the lamp cover holding the first, second, third and fourth lamps and reflecting light emitted by the first, second, third and fourth lamps.

7. The backlight assembly of claim 6, further comprising two lamp covers separated from each other, each of the lamp covers having an L-shape corresponding to the pair of the lamps arranged in the L-shape.

8. The backlight assembly of claim 7, wherein the pair of the output terminals that are electrically connected to each other, is grounded to the lamp cover.

9. The backlight assembly of claim 1, further comprising an optical element disposed on the light-guide plate and enhancing optical characteristics of light emitted by the lamps.

10. A liquid crystal display (“LCD”) apparatus comprising:
a backlight assembly supplying light, the backlight assembly including:
a light-guide plate;
a lamp part including first, second, third and fourth lamps respectively facing first, second, third and fourth side surfaces of the light-guide plate, each of the lamps including an input terminal and an output terminal, the output terminals of the first and second lamps being adjacent to each other, the output terminals of the third and fourth lamps being adjacent to each other, the input terminals of the first and fourth lamps being adjacent to each other, and the input terminals of the second and third lamps being adjacent to each other;
a receiving container receiving the light-guide plate and the first, second, third and fourth lamps; and
a power supply part converting a voltage applied from an external source, and applying the voltage to the first, second, third and fourth lamps; and
a display unit receiving the light from the backlight assembly and displaying images.

11. The LCD apparatus of claim 10, wherein a pair of the output terminals of the first and second lamps or the output terminals of the third and fourth lamps is electrically connected to each other,
each pair of the lamps having the output terminals electrically connected to each other is arranged in an L-shape, and
each of the input terminals of the first, second, third and fourth lamps is electrically connected to the power supply part.

12. The LCD apparatus of claim 11, wherein the pair of the output terminals that are electrically connected to each other, is electrically connected to the power supply part and fed back to each input terminal of respective lamps.

13. The LCD apparatus of claim 11, wherein the pair of the output terminals that are electrically connected to each other, is grounded to the receiving container.

14. The LCD apparatus of claim 11, wherein the lamp part further includes a lamp disposed facing adjacent side surfaces of the light guide plate, holding the first, second, third and fourth lamps and reflecting light emitted by the first, second, third and fourth lamps, and
the pair of the output terminals that are electrically connected to each other, is grounded to the lamp cover.

15. A method for manufacturing a backlight assembly, the method comprising arranging first, second, third and fourth lamps to respectively face first, second, third and fourth side surfaces of a light-guide plate, such that output terminals of the first and second lamps are adjacent to each other, output terminals of the third and fourth lamps are adjacent to each other, input terminals of the first and fourth lamps are adjacent to each other, and input terminals of the second and third lamps are adjacent to each other.

16. The method of claim 15, further comprising:
electrically connecting one of a pair of the output terminals of the first and second lamps to each other and a pair of the output terminals of the third and fourth lamps to each other; and
connecting each of the input terminals of the first, second, third and fourth lamps to a power supply part.

17. The method of claim 16, further comprising connecting the pair of the output terminals that are electrically connected to each other, to the power supply part, such that the electrically connected output terminals are fed back to each input terminal of respective lamps.

18. The method of claim 16, further comprising grounding the pair of the output terminals that are electrically connected to each other to a portion of the backlight assembly.

19. A backlight assembly comprising:
a light-guide plate;
a lamp part including first and second lamps respectively facing first and second side surfaces of the light-guide plate, each of the lamps including an input terminal and an output terminal, and the output terminals of the first and second lamps being adjacent to each other;
a receiving container receiving the light-guide plate and the first and second lamps; and
a power supply part converting a voltage applied from an external source, and applying the voltage to the first and second lamps.

20. The backlight assembly of claim 19, wherein a pair of the output terminals of the first and second lamps is electrically connected to each other, and
each pair of the lamps having the output terminals electrically connected to each other is arranged in an L-shape.
